(19) United States
(12) Patent Application Publication
(10) Pub. No.: US 2008/0094312 A1
(43) Pub. Date: Apr. 24, 2008

(54) FACILITATING GROUP DISCUSSION

(76) Inventor: David L. Feigenbaum, Winchester, MA (US)

Correspondence Address: FISH & RICHARDSON PC, P.O. BOX 1022, MINNEAPOLIS, MN, 55440-1022, US

(21) Appl. No.: 11/874,250

(22) Filed: Oct. 18, 2007

Related U.S. Application Data
(60) Provisional application No. 60/829,999, filed on Oct. 18, 2006.
(60) Provisional application No. 60/885,260, filed on Jan. 17, 2007.

(51) Int. Cl. G09G 5/00

(52) U.S. Cl. 345/2.2

(57) ABSTRACT

Among other things, a topic for group discussion is displayed in a public place at a scale that is visible to a group of people at the public place, contributions of users that relate to the topic are received from wireless devices of users who are at the public place, and at least portions of at least some of the contributions are displayed in the public place.

### CROSS REFERENCE TO RELATED APPLICATIONS

This application claims the benefit of the priority of U.S. provisional patent applications 60/829,999, filed Oct. 18, 2006, and 60/885,260, filed Jan. 17, 2007, the entire contents of both of which are incorporated here by reference.

### BACKGROUND

This description relates to facilitating group discussion.

A group discussion on a topic typically involves multiple communications which may share some common characteristics. The source of a communication may be a single party, for example, a human individual or sometimes a commercial or non-commercial institution or governmental body or occasionally an affiliation of groups of them. The target audience of the communication may include multiple people, typically ranging in number from a few to millions, in particular, dozens, hundreds or thousands. The message carried by the communication typically is not personal to or directed to any particular individual but rather to many (for example, all) of the members of the group. The message may be about a subject of common interest to at least some part of the group, for example, news, sports, entertainment, politics, human interest and other topics of the kind treated in newspapers and World Wide Web portals and in other media.

The kinds of communication described above may be accompanied by (and we use the phrase group discussion to refer also to) other kinds of communication and sequences of communication in either direction and both directions between the source and target, for example, a message that invites or evokes subsequent communications, contains a question or an answer, or summarizes, marks, highlights, paraphrases, or revises one or more prior communication in the sequence.

Group discussions may be facilitated by, for example, public meetings, kiosks, publicly placed electronic information boards, blogs, email, wikis, leaflets, and Internet chat groups.

### SUMMARY

In a general aspect, a topic for group discussion is displayed in a public place at a scale that is visible to a group of people at the public place, contributions of users that relate to the topic are received from wireless devices of users who are at the public place, and at least portions of at least some of the contributions are displayed in the public place.

The topic and contributions may be displayed in a second public place at essentially the same time as the display in the public place.

The contributions may be automatically filtered prior to display to remove inappropriate contributions.

There may be multiple topics having respective identifiers, and the identifier of the topic to which a contribution relates is indicated by the user from whom the contribution is received.

The public place may be in a large metropolitan area, and the second public place may be in a local area in the vicinity of the large metropolitan area.

These and other aspects of what is described in this application may be expressed as methods, apparatus, systems, program products, and in other ways. A wide variety of other advantages and features will become apparent from the following description, and from the claims.

### DESCRIPTION OF DRAWINGS

FIGS. 1 through 7 are block diagrams.

FIG. 8 is a display.

### DETAILED DESCRIPTION

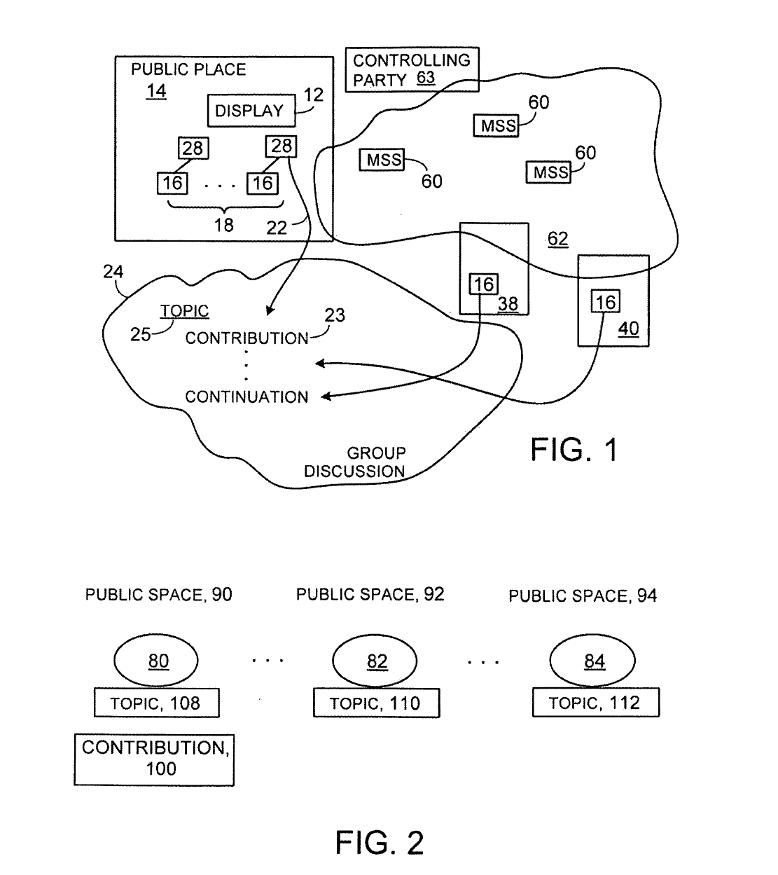

As shown in FIG. 1, in some examples of a system that facilitates group discussion 10, a large electronic display 12 is located in a public place 14 where it is visible at the same time to people who are members 16 of a group 18. Each person is typically in the public place only for a relatively short period of time (say from a few minutes to a few hours). The constituency of the group is constantly changing. Each member of the group may be (but is not required to be) a source of an electronic message or other communication 22 that is part of a group discussion 24. Typically the communications by people 16 are provided during the period when they are in the public space. In some implementations, the communications could be provided by people before or after that period. For example, a person could provide a communication while on a train bound for a train station where the display 12 is located. We sometime refer to such a communication as a contribution 23 to a group discussion, and to the party who makes the contribution as a contributor. Thus, each of the possible sources of communication in the public space may or may not be actual contributors of contributions to a group discussion. In some instances the location of the display is chosen because it is a place where people tend to be waiting (for example, a train station) and have time available to engage in a group discussion.

A wide variety of devices 28 can be used to compose and post a contribution. Some examples include mobile telephones, personal digital assistants, notebook computers, publicly accessible kiosks, all within the public space, and similar devices and others such as personal computers 37 located in other public places or in private places, including houses and apartments, offices, and schools. A contribution can be made from any location. A group discussion 24 can have a topic 25 that is often unrelated to the context in which the discussion occurs. For example, the topic could be the lack of garbage collection services in a part of a city, and the place where the group discussion occurs could be a train station in a different part of the city.

Contributions can be composed in any mode in which information can be created electronically, for example, by automatically recognized speech, automatically recognized handwriting, typing, test messaging, digital photography, and videography.

Contributions can be posed in any mode in which information can be delivered electronically, for example, wirelessly, by wire, by a dedicated communication channel, or through one or more private or public communications networks.

The topics and/or the contributions for one or more of the group discussions may be displayed at different times or at the same time on the display 12. The discussions can be displayed essentially in real time as the contributions are posted, or can be delayed and displayed later.

In some examples, a contribution is considered to have been posted when it is accepted from a contributor. Once accepted, the contribution is stored in a mass storage system (MSS) 60. The mass storage system 60 in some examples can be a stand alone storage device or a networked set of storage devices located in or associated with a particular public space 14. In some examples, the mass storage system 60 is part of an extensive network 62 of such storage systems that serve a one or more (potentially a very large number) of other public and private places 38, 40. Various portions of the mass storage systems 60 and of the network 62 may be controlled by one or more parties 63 including publishers, owners of public places, governmental bodies, or entertainment companies, to name a few.

As shown in FIG. 2, more than one (and as many as dozens, hundreds, or thousands of) group discussions 80, 82, 84 . . . may be in progress at a given time and over time. Public spaces may be associated with particular group discussions and vice versa. A given group discussion may be associated with a particular public space 90 or with more than one public space 90, 92, 94. And each public space can be associated with more than one group discussion. For example, a discussion about the chances of a certain baseball team winning the World Series could be conducted only in a ballpark associated with that team.

Each contribution 100 (and more than one of them) can be associated with one or more group discussions and with one or more public places. The associations can be arbitrary but typically a contribution and a group discussion are associated based on a match (for example, commonality) of subject matter. Typically, a contribution and a public place are associated based on a presence of the contributor in the public place. A group discussion and a public place are typically associated because of the presence of contributors to the group discussion in the public place or because a party in control of the public place permits or encourages the association.

On the other hand, some group discussions will span a large number of the places, for example, a discussion of the performance of Mayor Jones could be associated with all of the places in the city where Jones is the Mayor. Then all of the displays could (but would not be required to) show the contributions to that discussion at the same time. In effect, all of the people in all of those places would be participating in the same group discussion at the same time.

Each group discussion 80, 82, 84 has a topic 108, 110, 112. Typically (but not always) the topic of a group discussion is not broad or general, such as “fashion” or “cars,” nor is it so narrow as not to be interesting to many potential contributors who are present in a public place, such as the impact of a new piece of patent legislation on aboriginal Alaskan residents. More typical group discussions would have topics such as “sports team X's trade of player Y for player Z,” or “movie Q,” or “proposal to increase the legal age for drinking alcohol to 21 in state R,” or “the war in Iraq”. Topics of group discussions in some implementations are unrelated to the context of the public place. For example, it would be unusual and coincidental (but not prohibited) for a group discussion in South Station in Boston to relate to the architecture of South Station. In some examples, a group discussion could have a topic that does relate to the purpose for which the group has gathered in the public place. For example, for spectators at a football game, a topic of public discussion may be an “idea for the name to be given to a planned new stadium.” In some examples, a discussion may not have a predetermined or stated topic.

A topic of a public discussion can be selected or created in a wide variety of ways. In some examples, the topic is specified by the first contributor or a later contributor. In some examples, a third party such as a publisher or a government entity will define a topic of public interest. The defining of topics of public discussions can be unregulated, or proposals for topics may be posted but not used until approved by a regulating body. Similarly, postings of contributions may also be unregulated or may require an approval process (which may be automated and almost instantaneous using pattern recognition, artificial intelligence, and other well known techniques) before the contributions are used as part of a group discussion, in order to screen offensive contents. The screening of topics and contributions may be done in part automatically based on the content and in part by a person. Topics and contributions may also be screened to remove material that is offensive or inappropriate before it is displayed or in a very short time after it is displayed.

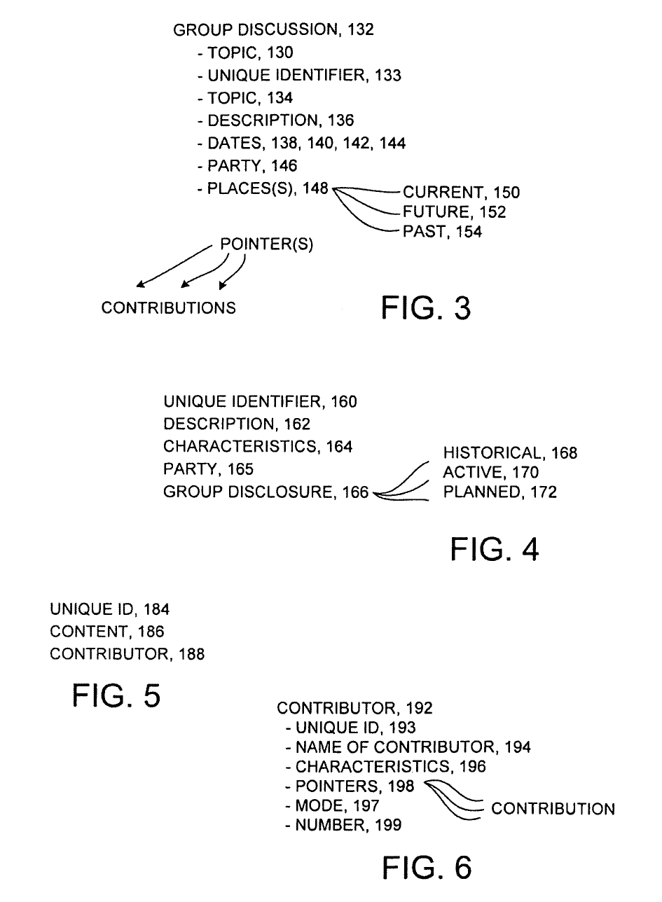

As shown in FIG. 3, a topic 130 of a group discussion 132 may, in some examples, be expressed in the form of a data structure that includes a unique topic identifier 133, the topic 134, a description of the topic 136, the date when the topic was proposed 138, approved 140, first used 142, and terminated 144, the party that defined the topic 146, one or more public places associated with the topic 148, each of which may be identified as one or more of current 150, future 152, or past 154, and pointers 156 to one or more contributions that are associated with the topic.

As shown in FIG. 4, in some implementations, each of the public places can be represented by a data structure 158 that includes, among other things, a unique identifier of the place 160, a description of the place 162, one or more characteristics of the place 164 (such as its size or its function), the party in control of the place 165, and pointers to one or more group discussions that are associated with the place 166 each of which may also carry one or more indicators of the state of the discussion in the place as historical 163, active 170, or planned 172.

As shown in FIG. 5, in some implementations, each of the contributions 180 can be represented by a data structure that includes, among other things, a unique identifier of the contribution 184, the content of the contribution 186 (for example, text, a photograph, a vide clip, or an audio file), information about the contributor 188, and pointers to one or more group discussions with which the contribution is associated.

In some examples, when a contributor posts a contribution, the contribution will typically identify, for example, by number, the group discussion to which it pertains. Thus when the contribution is posted, the storage system can create the digital structure for the contribution.

As shown in FIG. 6, in some implementations, data structures 190 may also be maintained in the storage system to represent respective contributors 192.

Each contributor data structure 190 could include, among other things, a unique identifier 192, a name of the contributor 194, one or more demographic characteristics of the contributor 196, pointers 198 to contributions contributed by the contributor, a mode of communication 197 (e.g., mobile phone), and perhaps a telephone number 199.

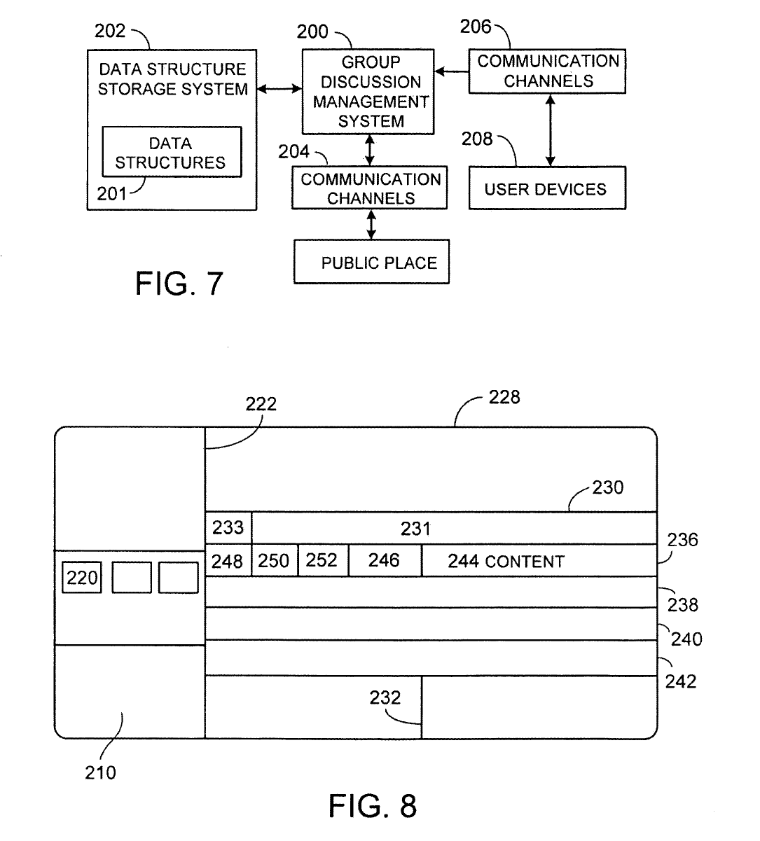

As shown in FIG. 7, the data structures 201 for the contributors, the contributions, the public places, and the group discussions, and any others that may be useful, can be created, received, stored, maintained, edited, deleted, and distributed as needed by a group discussion management system 200 to provide and enable one or more group discussions to be conducted in sequence or at the same time and in real time at one or more of the public places by groups and subgroups of and individual contributors.

For these purposes, the group discussion management system can access the data structure storage system 202, and can communicate over data and voice communication channels 204 with one or more of the public places, and over data and voice communication channels 206 with one or more user devices 208. The management system 200 can be a system that is local to one of the public places or can be distributed among and serve multiple public places.

As shown in FIG. 8, each of the public places has one or more displays 210 that are large enough to be viewed by more than one (sometimes, dozens or hundreds or even thousands or tens of thousands of) people at one time. The display is any device capable of displaying or performing the content of or other information about contributions, group discussions, or contributors, as text, graphics, or video material. Each display may be a physical display device or may be a virtual display that is projected on a surface or in space or is otherwise visible to viewers in the public places. The information that is shown or performed by the display is typically delivered to the display by the group discussion management system, either locally or from a central facility. Although at least one of the displays is located in a public place, the group discussions could also be displayed and viewed on individual work stations or hand held devices.

For simplicity, only one display device is shown in FIG. 8. A wide variety of types of entries 220 can be displayed simultaneously or in sequence in each of the various regions 222 of the display. The shapes, positions, number, and content of the regions can vary from public place to public place and can vary over time for a given display. Each region can contain any number of entries 220. The entries can include text, video, image, and audio content.

Each of several group discussions associated with the public place where the display is located can be displayed in its own region 228, 230, 232. The topic 231 and the number 233 of the topic can be shown at the top of the region. Under the topic, successive entries 236, 238, 240, 242 can be shown, for example in reverse chronological order based on the times when they were posted. Each entry could show the content 244 of the contribution for example, the text, together with its unique identifier 246, a pseudonym of the contributor 248 a time 250 when it was posted, and an indication 252 whether the contributor is currently in the public place, had been there or is planning to be there.

The group discussions facilitated in the way described here can yield important advantages to populations of people in companies, schools, families, neighborhoods, towns, cities, states, and in countries. Issues and questions that are important to such populations can be discussed in a public forum in a context in which the people making and watching the contributions are physically together and participating together in the experience. This can promote direct personal interaction among people who do not know one another, thus enhancing social fabric. People can derive a strong sense of participation in community issues and their solutions. People can be educated, encouraged to take action, and informed of the results of the cooperative effort of a larger group. The tendency of technology such as mobile phones, notebook computers, music players, and other devices to separate people and to reduce their interest in and ability to interact is countered by a system that uses similar technology to encourage public discussion, direct immediate interaction, and problem solving. The public places in which the group discussions can be displayed include, for example, convention centers, student centers at educational institutions, public transportation stations, street corners, public squares, hotel lobbies, sports facilities, hospitals, doctor offices, exercise facilities, inside buses, trains, subways, water taxis, coffee houses, and taxis. Places where people are stopped for a period waiting and have access to handheld communication devices are especially good.

The displays may be located in public places that are accessible to relatively small local populations. The size of the display, the topics covered, and the complexity of features offered could be varied based on the locality. For example, a display at Grand Central Station in New York City could be large, cover many topics, provide a wide range of features, include advertising, and be responsive simultaneously to a large number of contributors. A display in a small neighborhood park in New Rochelle could be relatively small, cover fewer topics, provide fewer features, and be responsive only to a couple of people at one time. The topics discussed on the display in the neighborhood park in New Rochelle could include narrow topics that relate, for example, to community activities in that town.

The system could be arranged to provide accessibility to handicapped people. The system could be hosted by a governmental agency or a non-profit organization and supported by donations or taxes, or could be operated by a for-profit venture and be supported by user fees that could be collected automatically through the use of the cell phones or other communication devices used to post contributions. Revenue could also be generated through subscriptions, advertising, rental, and in other ways. The locations, style of marketing, and selections of topics could be geared to attracting a diverse range of participants. Automatic translation services could be provided to encourage use by people who do not share a given native language.

The system could be linked or made compatible with other forms of communication including talk radio, wikis, chat rooms, and blogs, for example, by sharing common topics for discussion.

The public discussions that occur on the system could be summarized and distilled after the fact by volunteers or paid workers and posted, distributed, or communicated to others. The summarizations could include possible action steps, questions, and statements of results.

Highway message boards of the kind maintained by highway departments and visible on interstate highways and other roads could be integrated into the system.

People could be encouraged to participate in the discussion from personal computers at work or at home, that is in non-public places or contexts. The system could be used for political referenda to get people talking and to permit early informal polling. In some implementations, the system is structured to build connections among participants while maintaining their anonymity.

Displays could be associated with public art installations or one-time public events such as First Night celebrations. Displays could be portable and provided for short periods of time in public locations.

Links could be made with paper publications, for example, a morning newspaper could list a topic for the day to trigger thinking by its readers. The readers could later post contributions on the display.

People interested in a given topic could be introduced to one another, for example, through meals that are eaten at a pre-set time during the week at a pre-set place to have direct personal contact on the issues posted on the displays.

In some implementations, a live moderator (for example, a celebrity) could be present at one or more of the display locations to assist people in posting contributions, to define and refine topics, to screen postings, and to stimulate enthusiasm and participation.

Among the advantages of the system described here are one or more of the following.

It helps to break down barriers among people. People all over a city or country or the world will be talking to each other unconstrained by their physical locations. Ideas that are in people's heads can be brought out into public view more easily. Down time can be used effectively.

Community consensus can be built. Curiosity and laughter can be stimulated. Barriers can be broken down. By uniting media with the public, widespread attention can be focused on what people really think is important. Creative solutions can be drawn out of people. Macro communities can be developed through technology. Social class distinctions can be upended, for example, because a person is in the conversation if he is not driving, but rather taking public transportation.

The system helps to elevate the common person's interest in things that matter. It promotes freedom of speech.

The system upends the generational gap by forcing older generations to keep up with the technology if they want to be part of the public discussions.

The system provides a good way to conduct research.

Other advantages and features will become apparent and are within the scope of the following claims.

What is claimed is:

1. A method comprising
displaying in a public place at a scale that is visible to a group of people at the public place a topic for a group discussion,
receiving from wireless devices of users who are at the public place, contributions of the users that relate to the topic,
displaying in the public place at least portions of at least some of the contributions, and displaying the topic and contributions in a second public place at essentially the same time as the display in the public place, and
receiving from wireless devices of uses who are the second public place, contributions that relate to the topic, and
displaying in the public place and in the second public place at least portions of the at least some of the contributions received at the second public place.

2. The method of claim 1 in which the contributions are automatically filtered prior to display to remove inappropriate contributions.

3. The method of claim 1 in which there are multiple topics that have respective identifiers, and the identifier of the topic to which a contribution relates is indicated by the user from whom the contribution is received.

4. The method of claim 1 in which the public place is in a large metropolitan area, and the second public place is in a local area in the vicinity of the large metropolitan area.
